(19) United States
(12) Patent Application Publication
(10) Pub. No.: US 2020/0205213 A1
(43) Pub. Date: Jun. 25, 2020

(54) METHODS AND DEVICES ASSOCIATED WITH IMPROVEMENTS IN OR RELATING TO AN UPLINK SPLIT BEARER IN NEW RADIO

(71) Applicant: JRD COMMUNICATION (SHENZHEN) LTD, Nanshan Shenzhen, Guangdong (CN)

(72) Inventor: Olivier MARCO, Nanshan Shenzhen, Guangdong (CN)

(21) Appl. No.: 16/622,243

(22) PCT Filed: Jan. 4, 2018
(86) PCT No.: PCT/CN2018/071353

§ 371 Date: Dec. 12, 2019

(30) Foreign Application Priority Data
Jun. 16, 2017 (GB) 1709683.5

(51) Int. Cl. H04W 76/15; H04W 72/14; H04W 72/12

(52) U.S. Cl. CPC H04W 76/15; H04W 72/1252; H04W 72/14

(57) ABSTRACT

A method for enabling a wireless communication device to access services provided by a Network, the method comprising: implementing a dynamic uplink bearer split by enabling pre-allocating data to one or more of two or more links prior to transmission of data, using a configured split threshold.

### TECHNICAL FIELD

Embodiments of the present invention generally relate to wireless communication systems and in particular to devices and methods for enabling a wireless communication device, such as a User Equipment (UE) or mobile device to access a Radio Access Technology (RAT) or Radio Access Network (RAN), particularly but nor exclusively, in conjunction with,improvements in or relating to,an uplink split bearer in New Radio.

### BACKGROUND

Wireless communication systems, such as the third-generation (3G) of mobile telephone standards and technology are well known. Such 3G standards and technology have been developed by the Third Generation Partnership Project (3GPP). The 3^{rd} generation of wireless communications has generally been developed to support macro-cell mobile phone communications. Communication systems and networks have developed towards a broadband and mobile system.

The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

In NR, because of tighter time constraints/higher transport block (TB) size, the NR protocol specification was simplified to enable pre-processing (up to MAC SDU and associated sub header) to help the UE process a received UL grant in time. This was done mainly by removing RLC concatenation.

In NR system, it is also proposed, similarly to the LTE system, to support dual (or multiple) connectivity (DC). It is extended to cover both NR-NR or LTE-NR cases. In DC, the UE in connected mode is configured to utilise radio resources amongst E-UTRA and/or NR provided by multiple distinct schedulers connected via non-ideal backhaul. The scenario LTE-NR is particularly important, as it is envisioned that some initial NR deployments would use gNBs as secondary nodes added to a LTE legacy network.

In DC, a data radio bearer may be of different types: MCG bearer (if it uses resources from the master node cell group only), SCG bearer (if it uses resources from the secondary node cell group only), or split bearer (if it uses resources from both master and secondary nodes cell groups). In case of a split bearer, the PDCP entity is connected to 2 RLC entities (one from each link) which enables the data to be split between the 2 nodes. This allows in particular increased overall throughput. In a split bearer, the user data may be split in DL and/or UL. In the following, “UL split bearer”is used to indicate a split bearer for which it is possible to split user data over 2 links. The term “link” is used to indicate the RLC/MAC lower layers to which the PDCP entity is connected and towards which it may send data.

An uplink (UL) split bearer was initially discussed as part of LTE Rel-12. However, at this time only a DL split bearer was agreed. In UL, the user data was only sent to a pre-configured link. The UL split bearer was actually introduced in LTE Rel-13. However, the pre-processing was not a concern with LTE, as its need only appeared with New Radio (NR). Implicitly, the LTE design introduces a tight flow control between PDCP and RLC/MAC layers whereby whenever a UL split bearer is configured (this is derived from the presence of a PDCP data ul-DataSplitThreshold in the configuration), the PDCP PDUs are retained in PDCP until they are requested by lower layers of either link (UL grant on one of the link is received). Then, only the necessary amount of PDCP PDUs needed to fill the request originating from MAC LCP function are sent towards the link where the UL grant was received (with a restriction to prioritized link if PDCP data volume was below the threshold). Such a mechanism does not allow pre-processing up to MAC SDU/MAC sub-headers as routing is performed only after UL grant reception. In addition, it is interesting when an UL split bearer is configured to only trigger the transmission over 2 links when there is sufficient data to be transmitted. When the amount of data is small and can easily be transmitted on one link, it is not efficient to trigger transmission on both links. In LTE, as the data is retained in PDCP, this was easily implemented by comparing the amount of PDCP data (waiting to be transmitted) to a configured threshold (ul-DataSplitThreshold).

As can be seen, the LTE approach cannot be reused when there is a NR link, since it is desired to support pre-processing on the NR link. There is a need for a solution which could allow pre-processing on the NR link, and would also support a mechanism to trigger transmission on both links only when required.

Several proposals were discussed to design such UL data split for NR-NR or NR-LTE DC.

One proposal is to get rid of “dynamic split”, and instead use a “hard split” approach, such as incoming PDCP PDUs are routed to either link based on a fixed split ratio. However, this approach is known for its bad link performance as the fixed ratio will not match the maximum possible link throughputs. A main drawback of the split ratio approach is that it limits the rate ratio on both links to some specific value, which is not related to radio condition, load etc. A dynamic split approach, whereby the data is split dynamically between both links depending on the radio condition/load of each link is preferred, for performance reasons.

In order to implement “dynamic split”, one proposal is to reuse LTE dynamic split approach. However, this does not allow real pre-processing, as the data may be switched from one link to the other upon UL grant reception (implying reassignment of RLC SNs). In addition, this is more demanding for the UE than single connectivity.

Hence, a third proposal is to keep a “dynamic split” which would enable NR pre-processing, by allowing a limited amount of data to be pre-allocated (submitted) to NR link(s), before uplink grant reception. Such an approach can conciliate both link performance and real pre-processing possibility for NR link(s). It can be seen as a natural extension of LTE mechanism: the tight PDCP and/or Lower layers flow control is relaxed for NR link(s) in order to allow some limited data amount to be buffered in NR link lower layers. It is expected that this approach is the most promising as it keeps link performance benefits while still allowing real pre-processing for NR. However, this approach introduces new problems that need to be solved. In this approach, it is further important to minimize the amount of pre-allocated data. A problem is how to make sure that only the required amount of data is allowed to be buffered in lower layers. Then, a second problem is how to implement an efficient threshold mechanism to activate the UL data split.

The present invention acknowledges the above mentioned problems and realises the need to address the following issues.

The present invention is seeking to solve at least some of the outstanding problems in this domain.

The invention proposes a mechanism to minimize the amount of pre-allocated data.

The invention also describes a framework to combine pre-allocation with a threshold mechanism to activate the split operation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a first aspect of the present invention there is provided a method for enabling a wireless communication device to access services provided by a Network, the method comprising: implementing a dynamic uplink bearer split by enabling pre-allocating data to one or more of two or more links prior to transmission of data, using a configured split threshold.

Preferably, data is split over the links based on a configured split threshold.

Preferably, the activation data split over two links is based on a data volume being equal to greater than the configured split threshold.

Preferably, the configured split threshold includes data pre-allocated to one or more of the two or more links.

Preferably, the data volume is a PDCP data volume and includes the PDCP data submitted to one or more of the two or more links.

Preferably, the data volume comprises the PDCP data volume and the total data buffered for transmission for a corresponding logical channel in the one or more links in which PDCP data was submitted.

Preferably, the data volume comprises total data buffered for transmission for a bearer in a UE.

Preferably, the data volume comprises the PDCP data and the total data buffered for transmission for the corresponding logical channels in lower layers.

Preferably, when a UL data split is activated, the data volume used to activate the UL data split operation is not reported or made visible to either link, and the PDCP data volume is reported and made visible to either link.

Preferably, pre-allocating data to one or more of the two or more links prior to transmission of data is carried out on a lower layer (LL) maximum buffering value which is adjusted to a minimum value.

Preferably, the LL maximum buffering is minimised by using an expected maximum UL grant.

Preferably, the LL maximum buffering is minimised by an expected maximum LC TTI Throughput.

Preferably, one of an expected maximum UL grant and an expected maximum LC TTI Throughput are derived from a reference maximum UL grant or a reference maximum LC TTI multiplied by a MarginFactor configured to account for possible increase of the grant from a NW side.

Preferably, the expected maximum UL grant or the expected maximum LC TTI Throughput are derived from averaging previous UL grant values or previous LC allocation values from previous TTIs in which transmission for an LC took place.

Preferably, the averaging is performed using a time window based averaging or averaging over a configured number of samples.

Preferably, when using an expected maximum UL grant, the LL maximum buffering is derived by virtually running an LCP algorithm assuming a reception of the expected maximum UL grant and using the allocation returned for an LC; and wherein when using an expected maximum LC TTI Throughput the LL maximum buffering is the expected maximum LC TTI Throughput value.

Preferably, when a LL maximum buffering is being operated for a LC on a link, the UE requirements are relaxed such as only up to the LL maximum buffering limit may be expected to be sent in a TB for this LC, allowing the UE to send padding or other data otherwise even if it has additional data buffered for this logic channel.

Preferably, the data is pre-allocated to the or each link based on one or more of: buffered data to be transmitted being similar on each link; or a ratio of buffered data to be transmitted to LL Max Buffering being similar for each link.

Preferably, data is pre-allocated to only one link and retained in PDCP to possibly be used by the other link, based on one or more of: LL buffered data to be transmitted on the one link is maximal but not higher than PDCP buffered data; or a ratio of LL buffered data to be transmitted on the one link to LL Max Buffering is maximal but not higher than ratio of PDCP buffered data to Max Buffering for the other link.

Preferably, the link where data is allowed to be pre-allocated is a NR link, and the link where data is not allowed to be pre-allocated but has to be retained in PDCP is an LTE link.

Preferably, if buffered data is greater than the split threshold, then a PDCP part of the transmission will be made visible to all links and data will be pre-allocated on all links with different options.

Preferably, the network is one of a Radio Access Network; a New Radio/5G network and an LTE network.

According to a second aspect of the present invention there is provided a user equipment, UE apparatus for performing the method of another aspect of the present invention.

According to a third aspect of the present invention there is provided a base station

According to a fourth aspect of the present invention there is provided a non-transitory computer readable medium having computer readable instructions stored thereon for execution by a processor to perform the method of another aspect of the present invention.

According to a further aspect of the present invention there is provided a method for enabling a wireless communication device to access services provided by a Network, the method comprising: implementing a dynamic uplink bearer split by allowing pre-allocating data to one or more of two links prior to transmission of data, wherein the activation of the UL data split over two links is done when a data volume is equal or above a configured split threshold which includes data pre-allocated to one or more of two links if any.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 is a diagram showing an LTE-UL split bearer mechanism, in accordance with the prior art;

FIG. 2 is a diagram showing further relevant features relating to the FIG. 1 example, in accordance with the prior art;

FIG. 3 is a simplified diagram showing a first case routing of PDCP data, according to an embodiment of the present invention;

FIG. 4 is diagram showing a second case routing of PDCP data, according to an embodiment of the present invention;

FIG. 5 is simple diagram of a third case routing of PDCP data, according to an embodiment of the present invention;

FIG. 6 is a graph representing the derivation of an expected maximum UL grant value, according to an embodiment of the present invention;

FIG. 7 is a graph representing the derivation of an expected maximum LC TTI Tput value, according to an embodiment of the present invention; and

FIG. 8 is a diagram showing a hard split mechanism, according to an embodiment of the present invention.

### DETAILED DESCRIPTION OF THE PREFERRED EMBODIMENTS

Those skilled in the art will recognise and appreciate that the specifics of the examples described are merely illustrative of some embodiments and that the teachings set forth herein are applicable in a variety of alternative settings.

The invention is related to a method and system for an UL split bearer in NR. Particularly it is related to a method for splitting user data in UL between several links when at least one link is a NR link, and a method to decide when such splitting is activated rather than using a single pre-configured link.

One of the main differences in UL between NR and LTE is related to pre-processing. In NR, it is expected that the processing time between the reception of an UL grant and the transmission will be significantly shorter, along with a TB size significantly greater. The NR user plane protocol has hence been simplified to allow pre-processing of medium access control service data units (MAC SDUs) before reception of the UL grant. In particular, RLC concatenation was removed to allow such pre-pre-processing.

In single-connectivity, Packet data convergence protocol (PDCP) protocol data units (PDUs) can be pre-processed into radio link control service data units (RLC SDUs) and MAC SDUs. RLC and MAC headers or sub-headers can be pre-processed. When a UL grant is received, only the last RLC SDU may need to be segmented, which only requires very limited processing.

In dual-connectivity, in case of UL split bearer, the legacy LTE implementation does not allow for such pre-processing. Indeed PDCP PDUs are retained in PDCP until they are requested by lower layers often following an UL grant.

The standard agreements on this are as follows.

“A configurable threshold approach is used to determine if the UE should transmit on one more than one link. As a baseline, the buffer status is used as a threshold. Other thresholds such as data rates or delay may be considered.

If the level is below the threshold the UE transmits on one link; and if above the threshold enhancements can be considered to allow pre-processing and link performance”.

The present invention is related to enhancements that allow pre-processing and link performance while both links are used. It is also related to a threshold based mechanism adapted to such enhancements, allowing the transmission on several links to be performed only when required. The term “link” as used herein, is intended to denote either LTE or NR lower layer protocols, such as for example RLC/MAC in the context of dual or multiple connectivity, where a PDCP entity may be connected to several links. This is also occasionally referred to as “legs”.

An emphasis of the present invention is related to adapting the LTE UL split bearer mechanism to allow pre-processing on NR links.

Generally, for either LTE or NR, after reporting BSR i.e. buffer status for the logical channel groups, the UE should be able to process a received UL grant according to its capabilities, and maximize data transmission in this UL grant. The UE shall not transmit padding because it was unable to process on-time data that was requested to be transmitted earlier in a BSR. It needs to have the processing capability to handle a received UL grant on-time. Because of tighter time constraints/higher transport block (TB) size, the NR protocol specification was simplified to enable pre-processing to help the UE process the received UL grant on-time.

In the case of a UL split bearer, with at least one link using NR (i.e. NR-NR; NR-LTE; LTE-NR); the pre-processing should be possible on any link using NR. In any case, the main requirement for the UE is to be ready to transmit the data on-time irrespective of whether pre-processing is required or not. So called super UEs may be able to process a grant in real time, in which case they should be free to do so especially if this brings benefits.

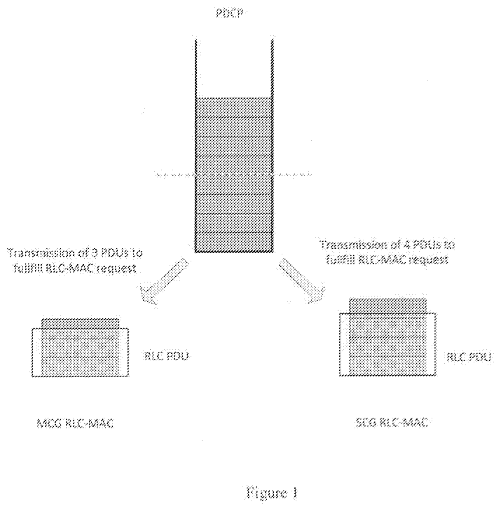

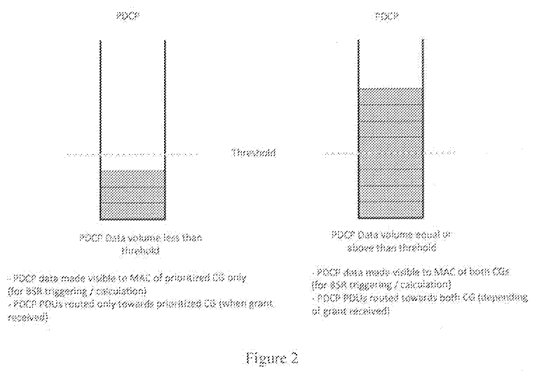

Implicitly, the LTE design introduces a tight flow control between PDCP and RLC/MAC layers. Whenever a UL split bearer is configured, the PDCP PDUs are retained in PDCP until they are requested by lower layers of either link, i.e. until an UL grant is received on one of the links. The UL split bearer configuration is derived from the presence of a PDCP data ul-DataSplitThreshold in the PDCP configuration. Once a UL grant is received, a predetermined number of PDCP PDUs needed to fill the request originating from MAC logical channel prioritization (LCP)function are sent towards the link where the UL grant was received. If PDCP data volume is below the configured ul-DataSplitThreshold threshold, the data transmission is restricted to a single link, a so-called “prioritized link”, which is configured by upper layers. This is described in the FIG. 1. As can be seen, this mechanism does not allow for pre-processing as routing is performed only after UL grant reception.

In addition, it is desirable that the transmission on both links is only performed when there is sufficient data to be sent. A goal is to avoid small data transmissions to trigger both links (SR, BSR, and then possible double grant allocation) when there is no advantages in doing this.

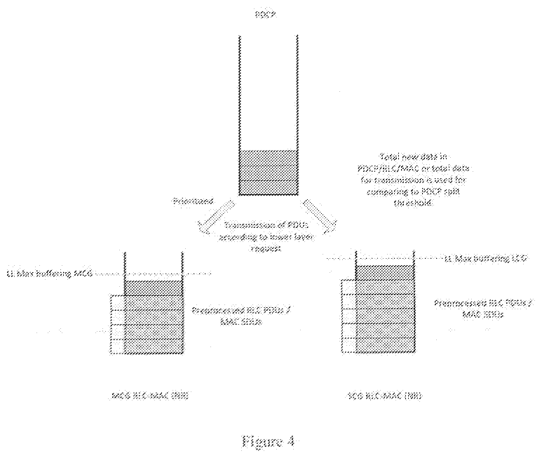

An implementation of this was proposed in LTE Rel-13 by using a configured threshold relative to PDCP data amount. This is described with reference to FIG. 4. The threshold is used twice. In a first instance, to make PDCP data “visible” for BSR triggering and/or calculation on one (when PDCP data amount is lower than the threshold) or both (when PDCP data amount is equal or higher than the threshold) links. In a second instance, the threshold is used to transmit PDCP PDUs, upon lower layers request, on one (when PDCP data amount is lower than the threshold) or both (when PDCP data amount is equal or higher than the threshold) links. In each instance, the one link is the prioritized link, as configured by upper layers. Regarding the second instance, it seems preferable that complete PDCP PDUs which can fit into the allocation subsequent to LCP for this LC, following a received UL grant on the non-prioritized link,should be allowed to be sent, even when the amount of PDCP data is lower than the threshold. Otherwise, this results in a waste of radio resources, as the UE will send padding. Conversely, when the amount of PDCP data is lower than the threshold and the UL grant was received on the non-prioritized link, PDCP PDUs which cannot fit into the allocation subsequent to LCP for this LC (following this UL grant should) not be submitted to the non-prioritized link, since only one part of PDCP PDU would be transmitted in the allocation, and the remaining part of the PDCP PDU would trigger further allocation on the non-prioritized link, which is not desirable.

As a result, the present invention seems likely to be relevant to both NR and LTE. It is also desirable to keep a similar threshold mechanism with a NR link, whereby the data will be split across both links above some threshold.

The present invention proposes a framework to combine UL split threshold with pre-allocation to one or more given link(s) and one or more ways to minimize pre-allocation on the one or more given link(s). It should be noted that the invention considers a form of allowed “pre-allocation” to NR links. In this invention pre-allocation refers to and is synonym to actual submission of data to NR link(s) prior to reception of an UL grant) rather than just pre-processing. The intent of pre-allocation to NR link(s) is to allow necessary pre-processing for UEs which require it. However the pre-processing itself should be left to UE implementation. A super UE, might not need any pre-processing. The invention seeks to minimize the impact of any such pre-allocation and also considers impact on UE requirements to fill the TB, based on the pre-allocation limit. The invention further sets out how the threshold can be used with a “total amount” of data buffered for a transmission.

Some background related to buffering data for UL transmission in LTE is needed, in order to better understand the requirements and constraints regarding UL transmission. First, it is necessary to understand that the typical BSR values may be quite high for continuous uplink traffic.

From the LTE baseline, it can be noted that the BSR range (maximum BSR threshold in the reporting table) is calculated based on the expected response time (between BSR calculation and UL grant), and the maximum UL rate on the cell group. The expected response time used is 2*RTT=16 ms. RTT stands for round trip time. In Rel-8, for one carrier and one layer, the maximum UL rate is 75 Mbps; hence this yields around 150 kB. This was later extended to support four layers and five convolution codes (CCs), which yields 3000 kB. This of course does not preclude the UE from buffering more.

As can be seen, the BSR range actually covers up to 16 times the buffering needed for transmission in 1 ms (a normal TTI duration in LTE). With NR, the expected response time will be lower, but the same principle will apply.

The UE may typically keep/report a buffer size (BS) which will represent several times the buffering needed for transmission in one TTI. This is generally true for any “continuous transmission”, or “long burst of data”. For BSR table calculation, an UL grant corresponding to the maximum possible allocation is assumed. However generally this may not be the case, depending on cell load and radio conditions. Generally, only x % of the maximum UL grant is allocated to the UE at each TTI. The same observation is valid in that case, i.e. the UE may typically report a BS, which will represent several times the buffering needed for transmission in one TTI. The NB scheduler will include the information to schedule the UE over several TTIs.

It should be noted that for a transmission control protocol (TCP) connection, it is typical TCP behaviour that the buffering on the transmitter side will increase, until the host flow control or AQM mechanisms are triggered. To a certain extent, this is beneficial as the UE will report higher BS and may expect the NB scheduler to increase its allocation.

With such high reported BSR values a problem is that the UE needs to be ready/prepared to transmit all the data in a single TTI, up to the maximum possible UL grant (according to its capabilities), whereas typically this will never be the case, as this would require the UE to be in perfect radio conditions.

It is also helpful to look at the ul-DataSplitThreshold values in LTE. The ul-DataSplitThreshold values in LTE are defined as follows:

| [[ ul-DataSplitThreshold-r13 CHOICE { | |
|---|---|
| ReleaseNULL, | |
| setup | ENUMERATED { |

b0, b100, b200, b400, b800,b1600, b3200, b6400, b12800,
b25600, b51200, b102400, b204800, b409600, b819200,
spare1}
OPTIONAL, -- Need ON

The values range from 0, 100, 200, . . . Bytes to 819 kB. It can be seen that there is a great flexibility for the operator to configure the split for arbitrary minimum amount of data. It is important to compare the threshold with the maximum theoretical data which can be transmitted in one TTI in one link. Assuming one CC, max 150 Mbps, this gives 18750B/TT. As a result, the SplitThreshold may need to be configured below or above the maximum data which can be transmitted per TTI on one link. It is important to keep this flexibility for the NR design.

As described earlier, in LTE baseline and current NR baseline, after reporting BSR i.e. buffer status for logical channel groups, the UE should be able to process a received UL grant according to its capabilities, and maximize data transmission in this UL grant (at least according to the previous BSR). As was mentioned earlier, typically the reported BSR will be very high (as it accounts for transmission over several TTIs), often more than the maximum theoretical UL grant which can be received on the link.

The UE shall not transmit padding because it was unable to process on-time data that it requested earlier to be transmitted in a BSR. Hence the UE needs to be prepared to transmit up to the maximum theoretical UL grant which can be received on the link, even if this never occurs. On a NR link, as indicated earlier, the specification should allow pre-processing, i.e. pre-allocation (submission) of data to NR lower layers (RLC/MAC). As a baseline, it can be considered that the maximum amount of data that can be expected to be transmitted during a TTI needs to be allowed to be pre-allocated to RLC/MAC. Without any enhancement, this means that up to the maximum theoretical UL grant which can be received on the link needs to be allowed to be buffered in RLC/MAC. Especially for NR, this value can be huge, and likely not acceptable in the context of UL split since this would degrade the performance in case of a link congestion.

Hence, it is important that such pre-allocation should be minimized, as any over allocation would degrade performance if a link is temporarily congested.

Thus, it is proposed that when a UL split bearer is configured, the NR links allow a lower layer (LL) maximum buffering limit (per link, per logic channel (LC)). The LL maximum buffering limit may refer to only “new data”, i.e. PDCP PDUs submitted to lower layers (and possibly pre-processed to RLC PDUs or MAC SDUs) or total data to be transmitted buffered in LL (including “new data”, RLC STATUS, RLC PDUs NACKed which shall be retransmitted).

The LL maximum buffering limit should also reflect the maximum data for this LC that the UE may be expected to send in a TB. In other word, the UE requirements are relaxed such as only up to LL maximum buffering limit may be expected to be sent in a TB for this LC. The UE would be allowed to send padding in case the UL grant and LCP rules would have required more data to be sent, if it has buffered data for this LC but was not able to process it on-time. If it has data ready for other LCs, such data might be transmitted instead to avoid radio resource waste. Different LL maximum buffering limit alternatives are described later in the document.

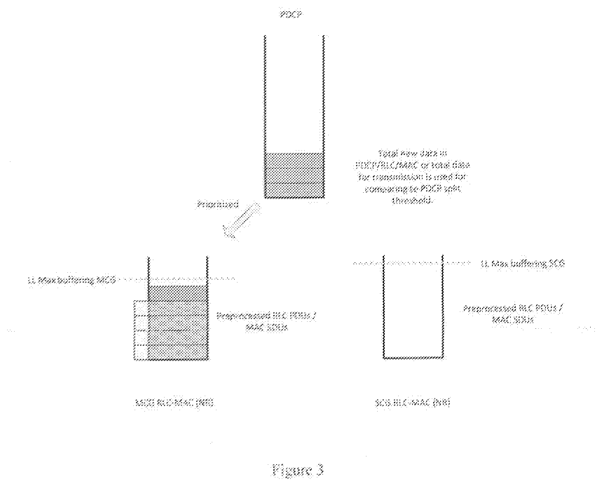

For the routing of PDCP data towards one or both links, there are two main use cases to consider: case A in which the UL split operation is not triggered and the PDCP data may be pre-allocated only to prioritized CG (configured by higher layers); and case B in which the UL split is triggered and the PDCP data should be pre-allocated to both CGs. Case A is shown in FIG. 3.

For case B, there are several sub-cases (assuming MCG is the prioritized group), these are:
B1—split_threshold is set to a relatively high value:
   (LL Max buffering MCG+LL Max buffering SCG)<=split_threshold
B2—split_threshold is set to an intermediate value:
   LL Max buffering MCG<=split_threshold<(LL Max buffering MCG+LL Max buffering SCG)
B3—split_threshold is set to a relatively low value:
   split_threshold<=LL Max buffering MCG

Referring to FIG. 4, Case B1 is assumed to be the main use case, especially if LL Max buffering MCG/SCG can be minimized as proposed below.

Cases B2/B3 may be supported, especially if LL Max buffering MCG/SCG cannot be minimized (e.g. needs to match the maximum UL grant which can be received on each link). Indeed, in that case it might be desired to start the split earlier. As was discussed before, the LTE split threshold configuration allows this, as it can be set to values as low as 100 B. There are several alternatives: Alt1 in which the prioritized CG is used first. The UE will pre-allocate data to prioritized CG, up to LL Max Buffering for the prioritized CG. Then it will pre-allocate to the un-prioritized CG; and Alt2 in which both CGs are used, independently of the configured prioritized CG. It can be noted that in LTE baseline, when the UL split is triggered, the data is split according to incoming UL grants. The configured prioritized CG is only used when the UL split is not triggered.

A problem with using Alt1 is that if there is not enough buffered data, only prioritized CG might be used (in case B3), whereas the intended behaviour is to use both links, and accordingly, any temporary buffered data in PDCP might have been made visible to both links, resulting in UL grants on both links. As a result, Alt2 may be preferable. Also, Alt2 would be closer to LTE baseline. In this case, some rules may be needed to pre-allocate data towards each link. It is proposed to pre-allocate data to links according to one of the following rules: buffered data to be transmitted is similar on each link; or the ratio of buffered data to be transmitted to LL Max Buffering is similar for each link. This will ensure that the data is split according to the dynamic data rate on each link. The second rule is preferred as it allows to better match cases where the throughput of the links could be significantly different.

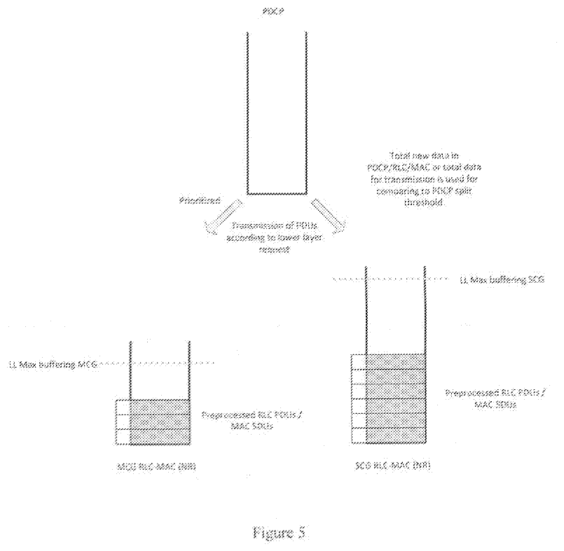

The following FIG. 5 describes the option where the data is pre-allocated to ensure a similar ratio of buffered data to LL Max Buffering on each link. For cases B2/B3 the data is split proportionally to LL Max buffering. When one of the link is non-NR, e.g. LTE, no pre-allocation of data may be needed (no LL buffering may be needed). In such case, the same principle can apply, considering that data buffering for the LTE link needs to remain in PDCP, as no data needs to be allocated to lower layers. For LTE link, a maximum buffering value may be derived similarly as explained below for the NR link. The maximum buffering value can be used in the routing algorithm to split the data between the NR link and LTE link (for the LTE link, the buffered data stays in PDCP). It is understood that there is no need to inforce some buffered PDCP data to be later transmitted on the LTE link; what is needed is just to retain the needed amount of data, according to the routing algorithm, in PDCP for a potential usage by the LTE link.

There are different possible modelling options that may be implemented, these include, the following.

The routing of PDCP data maybe similarly to LTE i.e. on request by lower layers. In the case of a LTE link, the LL maximum buffering is 0. In such a case, an UL grant triggers the request to PDCP. In the case of a NR link, the LL maximum buffering is >0. In such a case, the UE is allowed but not mandated, if it does not need it, to pre-allocate data to a link up to LL maximum buffering. It can then pre-process it (or part of it) so as to be ready in case of an UL grant. This modelling assumes that the maximum amount of buffered data is configured by PDCP to lower layers, and lower layers are requesting the corresponding amount of data when needed.

The PDCP may alternatively submit the data assuming it has visibility on the LL buffering status. This may be easier to implement in the specification.

In the following section, we describes several alternatives to derive the LL maximum buffering value. There are two main ways to derive the LL maximum buffering value (for a given logical channel, on a given link). It might be derived from a maximum UL grant value; or derived from maximum LC TTI throughput value. In addition, it may also be possible to reduce further LL maximum buffering value (for any of above approaches) by taking into account earlier BSR reporting: only up to the buffer status value reported in the last BSR is required to be buffered.

First, we consider alternatives where the LL maximum buffering value is derived from a maximum UL grant value.

In NR, a LC can be mapped/restricted to different numerologies and/or carriers. In such a case, there might be different UL grant (on different numerologies and/or carriers) which enables transmission for this logical channel.

A single UL grant is now considered, but the principle can be generalized in case several UL grants can enable transmission of the LC, by applying the procedure on each possible UL grant source (numerology/carrier). This would yield a LL maximum buffering for each UL grant source, which can be aggregated to a total LL maximum buffering value.

The maximum UL grant value may be: the maximum UL grant according to UE capabilities; configured by the NW, semi-statically (RRC) or dynamically (MAC); or a maximum expected UL grant value. In the former case this could be the reference, i.e., the UE may expect to receive at any time a UL grant allocating maximum UL resources (naturally at least up to the amount of data it has signalled to the NW). A concern is that, this value will be typically very high. A drawback of the second case, is that this can limit tie throughput or lead to excessive signalling. Regarding the third option, this would aim to adapt the buffering to the actual scheduling and is further detailed below.

Knowing the maximum UL grant value, the LL maximum buffering could be derived as follows: assuming the total maximum UL grant value might be used for the LC (this is not optimized, but simple); or by using LCP prediction, which enables minimizing the LL maximum buffering for each LC taking into account LCP (QoS). LCP prediction is detailed further below.

We now describe further how a maximum expected UL grant value could be derived. A reference UL grant value may be derived from previously received UL grants by determining either: an average over a fixed time window, ignoring TTI without grants; or an average over the N last UL grants. The reference UL grant value may also be derived from PHY dynamic parameters (MCS).

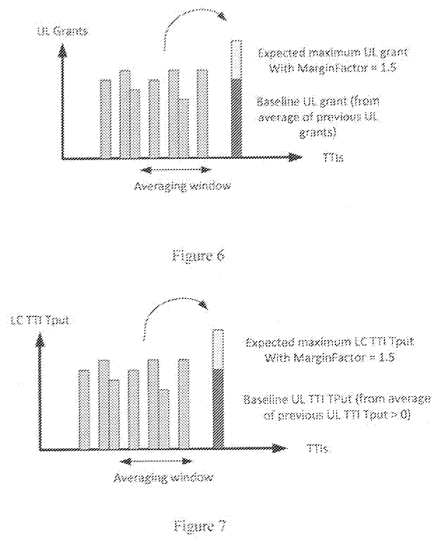

An expected maximum UL grant value can be derived from this reference value as follows: the expected maximum UL grant=reference UL grant*MarginFactor (clipped to maximum UL grant value). In this formula, MarginFactor>=1 is a parameter which can be configured by the NW in order to allow the NW to increase the grant value without taking the risk to have the UE send padding. The initial value (when there is no existing history) might be set to the maximum UL grant value, according to UE capabilities. This is shown in FIG. 6.

LCP (Logical Channel Prioritization) prediction is applicable assuming some maximum UL grant value is assumed. It enables to take into account QoS when several bearers are configured. In legacy LTE reference, the LCP function is performed by MAC on reception of an UL grant, in order to split transmission resources between the different bearers having available data for transmission (buffered data), taking into account QoS (priority of logical channels, Prioritized Bit Rate). On determination of a maximum UL grant value, the UE can simulate LCP procedure results if it receives such grant later. For example, in the following TTI, by running (virtually or otherwise) LCP procedure taking into account the impact of running the procedure in advance and assuming it has received such UL grant. This may require the need to take into account increases of token buckets for PBR calculation. This would give rise to how much data would be needed for each LC for that grant, which can be used as the LL maximum buffering value. As a simple example, assuming another RB has the same priority (and buffered data); only half of the maximum UL grant value needs to be buffered since in that case LCP would require the transmission resources to be split between both bearers.

The following alternatives are considered where the LL maximum buffering value is derived from a maximum LC TTI throughput value. As an alternative to considering the UL grant value, which is global to all LCs in the cell group, the UE may consider the LC throughput in the cell group, which already takes into account LCP considerations. In the following, “LC TTI throughput” is referred to as the amount of data for the LC allocated as part of an UL grant on a TTI. It may be 0 (e.g. if no grant was received in that TTI, or if LCP resulted in no data sent for this LC).

Similarly as discussed above, a LC can be mapped/restricted to different numerologies and/or carriers. In such a case, there might be different UL grant (on different numerologies and/or carriers) which enables transmission for this logical channel.

In the following, a single UL grant is considered, but the principle can be generalized in case several UL grants can enable transmission of the LC, by applying the procedure on each possible UL grant source (numerology/carrier). This would yields a LL maximum buffering for each UL grant source, which can be aggregated to a total LL maximum buffering value.

The maximum LC TTI throughput value may be: corresponding to the maximum UL grant according to UE capabilities; configured by the NW, semi-statically (RRC) or dynamically (MAC); or a maximum expected LC TTI throughput value. In the first scenario this would be the reference, i.e., the UE may expect anytime to receive an UL grant allocating maximum UL resources (naturally at least up to the amount of data it has signalled to the NW). A concern is that, this value will be typically very high. Regarding the second scenario, a drawback is that this can limit the throughput or lead to excessive signalling. Regarding the third scenario, this would aim to adapt the buffering to the actual scheduling and is set out in greater detailed below.

Then, the LL maximum buffering can then be set to the maximum LC TTI throughput value (LCP is already taken into account in this approach).

The manner in which a maximum expected LC TTI throughput value could be derived will now be described. A reference LC TTI throughput value may be derived from previously sent data for this LC by determining an average over a fixed time window, ignoring TTI without grants; or by using an average over the N last UL grants. When performing the average, it can decided whether or not to include UL grants with no sent data for this LC. It is preferred to take into account only TTIs (UL grants) for which data was sent, as this enables correctly taking into account the PBR behaviour. Indeed, typically low priority bearers will fulfil the PBR by sending one PDU each x TTIs, so thatan average PBR is met.

An expected maximum LC TTI throughput value can be derived from this reference value as follows: expected maximum LC TTI throughput value=reference LC TTI throughput value*MarginFactor (clipped to maximum LC TTI throughput value, i.e. maximum UL grant value). Where MarginFactor>=1 is a parameter which can be configured by the NW in order to allow the NW to increase the LC TTI throughput value without taking the risk to have the UE send padding. The initial value (when there is no existing history) might be set to the maximum LC TTI throughput value, according to UE capabilities. The above is shown in FIG. 7.

The concept of LL maximum buffering can also be extended to single connectivity use case. It can be used as assistance information for the UE to limit lower layer buffering. This allows for more efficient transmission discard mechanism; and more efficient prioritization mechanism in the UP stack. For example, prioritization of TCP ACKs or other priority data.

The threshold operation needed to trigger UL split operation when required will now be considered. In LTE, the threshold is related to buffered PDCP data. However, in LTE, in case of split bearer operation, a tight flow control is implicitly assumed when a split bearer is configured, such as PDCP PDUs remain stored in PDCP until requested by lower layers (this is not the case for non-split operation). This means that for the most part, the data to be transmitted is buffered into PDCP (only RLC SDU segments, RLC STATUS or RLC PDUs to be retransmitted are to be transmitted but not stored in PDCP, and this typically represents a much lower amount). Hence, the use of PDCP data volume basically boils down to looking at how much UL data needs to be transmitted.

It would be beneficial to keep such approach, as the UL split is activated whenever the buffered data to be transmitted is higher than a threshold. This can be the case when incoming throughput increases compared to what could provide the prioritized link, or when there is congestion on the prioritized link.

In NR, the protocol design should allow pre-processing on NR link(s). This means that some data can be pre-allocated (submitted) on NR link(s) before UL grant arrival. This is actually needed whatever the split solution, dynamic or hard split. Keeping a threshold based on PDCP data volume is not preferred as it prevents to set the threshold to less than (LL Max buffering MCG+LL Max buffering SCG). As discussed above, it seems important to keep such flexibility, that exists in LTE baseline.

It is possible to keep, the LTE approach if instead of considering only PDCP data volume, in addition, a consideration is made of the data volume which was submitted and buffered in NR lower layers. I.e., the threshold should be related to either the “total new data” (PDCP data, as well as PDCP PDUs already sent and buffered in lower layers), or “total data” to be transmitted for this bearer (including also RLC data NACKed, which shall be retransmitted, RLC STATUS). It seems easier to consider total data.

This can be applicable whenever there is at least 1 NR link, i.e. for NR-NR or NR-LTE UL split operation. For LTE link, the buffered data in lower layers might be taken into account (to align with NR) or not (to keep same mechanism as in LTE)—as discussed above, this does not make much difference.

In LTE, the threshold is used twice: to make PDCP data “visible” for BSR triggering and/or calculation on the prioritized link (if below the threshold) or both links (if above the threshold), and to route the PDCP data towards the prioritized link (if below the threshold) or both link (if above the threshold).

The same principle could be used, for both purposes, with the change related to the data volume considered. The same data volume metric and threshold should be used for both purposes.

A difference compared to LTE, is that in LTE the amount of PDCP data is used both for BSR triggering and/or calculation and as a metric to activate the UL split (routing to both links and making data visible to both links). In the present invention, the amount of PDCP data is used both for BSR triggering (this would also be needed for the LTE link) and/or BSR calculation, but the metric to activate the UL split (routing to both links and making data visible to both links) is different.

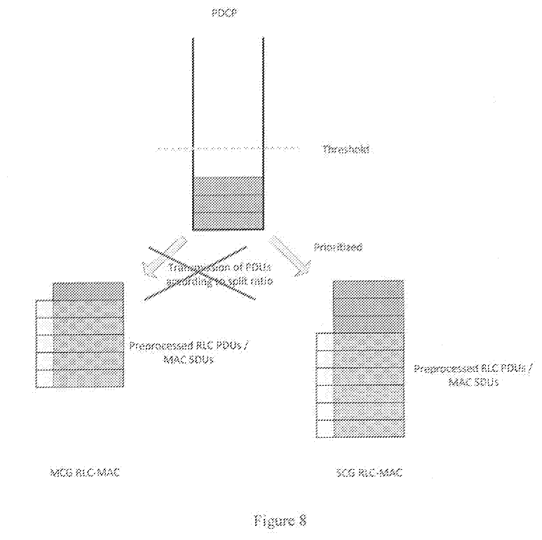

As discussed previously, a “hard split” approach is also discussed, in which the PDCP PDUs are distributed to both links according to a configured ratio. Without specified flow control between PDCP and lower layers, the PDCP data volume can also no longer be used as a metric, since the data remaining buffered in PDCP would be dependent on the implementation. Assuming the PDCP SDUs are processed to PDCP PDUs and routed as soon as possible, the new data would remain mostly buffered in RLC/MAC layers. It is possible then that the PDCP data would mostly remain below the configured threshold, which would lead to the data being sent towards the prioritized CG, as described below with reference to FIG. 8.

An option to use data rate metric was proposed. However, what should be the trigger for using both links is the amount of data to be transmitted. This would also be similar to LTE. Hence the following alternatives for the data volume to be compared to the threshold can be considered also for the hard split approach: total buffered “new data”, in PDCP as well as RLC/MAC layers; or total buffered data to be transmitted, in PDCP as well as RLC/MAC layers (“new data”+RLC STATUS+RLC data NACKed, which shall be retransmitted).

The following is an example of high-level text proposal for MAC/PDCP based at least on some of the embodiments mentioned above.

Related to BSR triggering and/or calculation, in MAC specification (using LTE baseline):

For split bearers, when indicating the data available for transmission in PDCP to a MAC entity for BSR triggering and Buffer Size calculation, the UE shall:
if ul-DataSplitThreshold is configured and the total buffered data (including data pre-allocated in NR link(s)) is larger than or equal to ul-DataSplitThreshold:
   indicate the data available for transmission in PDCP to both the MAC entity configured for SCG and the MAC entity configured for MCG;
else:
   if ul-DataSplitDRB-ViaSCG is set to TRUE by upper layer [3]:
      indicate the data available for transmission in PDCP to the MAC entity configured for SCG only;
      if ul-DataSplitThreshold is configured, indicate the data available for transmission in PDCP as 0 to the MAC entity configured for MCG;
   else:
      indicate the data available for transmission in PDCP to the MAC entity configured for MCG only;
      if ul-DataSplitThreshold is configured, indicate the data available for transmission in PDCP as 0 to the MAC entity configured for SCG.

Related to data routing, in MAC specification:

When submitting a PDCP Data PDU to lower layer, the transmitting PDCP entity shall:
if pdcpDuplication is activated:
   duplicate the PDCP Data PDU and submit it to each RLC entity associated with the PDCP entity;
else:
   if the total buffered data available for transmission (including data pre-allocated in NR link(s))is less than ul-DataSplitThreshold:
      submit it to the configured RLC entity;
   else:
      submit it to one of the associated RLC entity.

In addition:
For split bearers, PDCP submits PDCP PDU to LTE lower layers when requested by LTE lower layers (following UL grant arrival and LCP procedure).
   In case the request comes from the non-configured RLC entity whereas PDCP shall only submit to the configured entity, it is allowed to submit PDCP PDUs to the non-configured entity as long as the PDCP PDUs fit in the lower layers request
   (note: this is not in LTE, not sure why, it is also proposed to attempt an opportunistic change for LTE following NR discussion).
For split bearers, PDCP may submit PDCP PDUs to NR lower layers as long as the data available for transmission in LL is lower than LL Maximum buffering limit for this LC and link.
   When submitting data towards 2 NR CGs, PDCP should ensure that the ratios of buffered data to LL Maximum buffering limit for each link are similar.
   When submitting data towards 1 NR CG and 1 LTE CG, PDCP should ensure that the ratio of buffered data to LL Maximum buffering limit for NR link is maximal but not higher than the ratio of PDCP buffered data to LL Maximum buffering limit for LTE link.

Related to LCP procedure: in MAC specification;
The UE shall also follow the rules below during the scheduling procedures above:
   [ . . . ]
   for a given LC, the UE may not transmit more than LL maximum buffering value for this LC

LL maximum buffering for one LC is configured by upper layers. (simple)

Or

LL maximum buffering for one LC is calculated as follow: (more optimized)

LcTtiTput=running average of amount of LC data over the last LcTTiNb transmissions in the cell, or corresponding to maximum UL grant if there is no earlier transmissions for this LC in the cell

LL maximum buffering=LcTtiTput*MarginFactor

LcTputTTiNb and MarginFactor are configured by upper layers per LC.

From the above proposals and examples, an efficient means of handling split bearing is illustrated and described. The present invention relates to any uplink dynamic split bearer configuration irrespective of the standard.

Although not shown in detail any of the devices or apparatus that form part of the network may include at least a processor, a storage unit and a communications interface, wherein the processor unit, storage unit, and communications interface are configured to perform, the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general-purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory,such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory

In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organisation.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. In addition, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular, the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ or “including” does not exclude the presence of other elements.

1. A method for enabling a wireless communication device to access services provided by a Network, the method comprising: implementing a dynamic uplink bearer split by enabling pre-allocating data to one or more of two or more links prior to transmission of data, using a configured split threshold,
wherein data is split over the links based on a data volume which is pre-allocated to one or more of the two or more links,
wherein an activation of data split over two links is based on a data volume being equal to or greater than the configured split threshold,
wherein the data volume is the volume of total buffered new data in the PDCP and RLC/MAC layers, excluding RLC data which is to be retransmitted.

2. The method of claim 1, wherein data is split over the links based on a data volume which is pre-allocated to one or more of the two or more links.

3. The method of claim 2, wherein submission of data to a single prioritized link configured by upper layers is based on a data volume being lower than the configured split threshold.

4. The method of claim 3, wherein the configured split threshold includes data pre-allocated to one or more of the two or more links.

5.-8. (canceled)

9. The method of claim 3, wherein when a UL data split is activated, the PDCP data volume is reported and made visible to either link, otherwise it is reported and made visible to the prioritized link configured by upper layers.

10. The method of claim 1, wherein pre-allocating data to one or more of the two or more links prior to transmission of data is carried out on a lower layer (LL) maximum buffering value which is adjusted to a minimum value.

11. The method of claim 10, wherein the LL maximum buffering is minimised by using an expected maximum UL grant.

12. The method of claim 10, wherein the LL maximum buffering is minimised by an expected maximum LC TTI Throughput.

13. The method of claim 10, wherein one of an expected maximum UL grant and an expected maximum LC TTI Throughput are derived from a reference maximum UL grant or a reference maximum LC TTI multiplied by a Margin Factor configured to account for possible increase of the grant from a NW side.

14. The method of claim 13, wherein a reference maximum UL grant or the reference maximum LC TTI Throughput are derived from averaging previous UL grant values or previous LC allocation values from previous TTIs wherein transmission for an LC took place.

15. The method of claim 14, wherein the averaging is performed using a time window based averaging or averaging over a configured number of samples.

16. The method of claim 12, wherein when using an expected maximum UL grant, the LL maximum buffering is derived by virtually running an LCP algorithm assuming a reception of the expected maximum UL grant and using the allocation returned for an LC; and wherein when using an expected maximum LC TTI Throughput the LL maximum buffering is the expected maximum LC TTI Throughput value.

17. The method of claim 12, wherein when a LL maximum buffering is being operated for a LC on a link, the UE requirements are relaxed such as only up to the LL maximum buffering limit may be expected to be sent in a TB for this LC, allowing the UE to send padding otherwise even if it has additional data buffered for this.

18. The method of claim 10, wherein the data is pre-allocated to the or each link based on one or more of: buffered data to be transmitted being similar on each link; or a ratio of buffered data to be transmitted to LL Max Buffering being similar for each link.

19. The method of claim 10, wherein data is pre-allocated to only one link and retained in PDCP to possibly be used by the other link, based on one or more of: LL buffered data to be transmitted on the one link is maximal but not higher than PDCP buffered data; or a ratio of LL buffered data to be transmitted on the one link to LL Max Buffering is maximal but not higher than ratio of PDCP buffered data to Max Buffering for the other link.

20. The method of claims 19, wherein the link where data is allowed to be pre-allocated is a NR link, and the link where data is not allowed to be pre-allocated but has to be retained in PDCP is an LTE link.

21. The method of claim 10, wherein if buffered data is greater than the split threshold, then a PDCP part of the transmission will be made visible to all links and data will be pre-allocated on all links with different options.

22. The method of claim 1, wherein the network is one of a Radio Access Network; a New Radio/5G network and an LTE network.

23. A user equipment, UE, apparatus comprising a processor, a storage unit and a communications interface, wherein the processor unit, storage unit, and communications interface are configured to perform the method as claimed in claim 1.

24. A base station, BS, apparatus comprising a processor, a storage unit and a communications interface, wherein the processor unit, storage unit, and communications interface are configured to perform the method as claimed in claim 1.

25. A non-transitory computer readable medium having computer readable instructions stored thereon for execution by a processor to perform the method according to claim 1.

26. A method for enabling a wireless communication device to access services provided by a Network, the method comprising: implementing a dynamic uplink bearer split by allowing pre-allocating data to one or more of two links prior to transmission of data, wherein the activation of the UL data split over two links is done when a data volume is equal or above a configured split threshold which includes data pre-allocated to one or more of two links if any.

27. A method according to claim 1, wherein the PDCP entity is connected to two RLC entities (one from each link) by enabling submission of data to one or more of two or more RLC/MAC lower layer protocol links prior to reception of an uplink grant, using a configured split threshold and a data volume comprising the PDCP data volume and the PDCP PDUs already sent and buffered in lower layers.

28. The method of claim 1, wherein submission of data to a single prioritized link configured by upper layers is based on a data volume being lower than the configured split threshold
